(19) United States
(12) Patent Application Publication
(10) Pub. No.: US 2003/0090438 A1
(43) Pub. Date: May 15, 2003

(54) Foldable portable information terminal device and method for information display of the device

(76) Inventors: Noriyoshi Sato, Kanagawa (JP); Yoshito Ishikawa, Kanagawa (JP)

Correspondence Address: PEARNE & GORDON LLP, 526 SUPERIOR AVENUE EAST, SUITE 1200, CLEVELAND, OH, 44114-1484, US

(21) Appl. No.: 10/275,379

(22) PCT Filed: Jan. 10, 2002
(86) PCT No.: PCT/JP02/00097

(30) Foreign Application Priority Data
Jan. 30, 2001 (JP) P 2001-021951

(51) Int. Cl. G09G 5/00

(52) U.S. Cl. 345/1.1

(57) ABSTRACT

It is an object of the invention to provide a folding type portable information terminal device capable of confirming necessary information also in a folding condition, and furthermore, confirming the necessary information with the device put to an ear during use.

In order to attain the object, the invention provides a folding type portable information terminal device in which an upper housing (1) provided with a receiving portion 7 and a lower housing (2) provided with a transmitting portion (19) are coupled to each other to be foldable through a hinge portion (3), wherein the lower housing (2) is formed to be longer than the upper housing (1), a protruded portion of the lower housing (2) is protruded from the upper housing (1) in a folding condition and a display device (24) is provided on an opposed surface side of the protruded portion to the upper housing (1). Consequently, the display device (24) is exposed also in the folding condition. Therefore, a user can confirm information displayed on the display device (24) without opening and can visually recognize the display device (24) with a receiving portion (7) put to his (her) ear in an opening condition.

### TECHNICAL FIELD

The present invention relates to a folding type information terminal device including a display device such as a portable telephone, a notebook type personal computer or a portable information terminal device, and more particularly to a folding type information terminal device capable of visually recognizing information displayed on the display device in a folding condition and an information display method thereof.

### BACKGROUND ART

FIGS. 7 and 8 are views showing the appearance of a conventional folding type portable telephone described in JP-A-8-163638. FIG. 7 shows a state in which a body is closed and FIG. 8 shows a state in which the body is opened. In the conventional folding type portable telephone, a first body portion 80 and a second body portion 81 are openably coupled to each other through a coupling portion 82. The first body portion 80 comprises a liquid crystal display 83 for visibly displaying various information, an antenna 84 and a button switch 85. The second body portion 81 comprises various function button switches 86 including character and numeral input switches.

In such a state that the folding type portable telephone is folded, the liquid crystal display 83 and the function button switch 86 are opposed to each other. In an opening condition, the liquid crystal display 83 and the function button switch 86 are exposed together. In general, the liquid crystal display 83 serves to display time information, to display set information about a mode which can be set to a device such as an electronic message setting mode or a manner mode, and to display information indicative of an electric field strength and the outside of a range as is described in JP-A-9-321839, for example. In the case in which various information are to be displayed on the display device, the information about the electric field strength and the outside of a range are displayed in a first line portion on the upper end side of the liquid crystal display and input character information and image information are displayed in other display portions.

In the conventional folding type portable telephone, the whole liquid crystal display is hidden in a folding condition. Therefore, the displayed information cannot be seen. For this reason, the body portion is to be opened at each time in order to confirm various information. Consequently, there is a problem in that a user feels troublesome.

In recent years, moreover, the transmission and receipt of an electronic mail using a portable telephone has been started to spread rapidly. In this case, it is hard to display the contents (text) of the electronic mail while displaying time information or various setting modes on a small display device of the portable telephone. For this reason, specific information is not displayed or various setting modes are displayed on a part of the liquid crystal display and the contents of the electronic mail are displayed in other portions. However, the user is to repetitively start a new line and a new page in order to display and read the whole text of the electronic mail, which is complicated.

The invention has been made in consideration of the problems described above and has an object to provide a folding type information terminal device by which a user can see various information without feeling troublesome, and an information display method thereof.

### DISCLOSURE OF THE INVENTION

The above object can be attained by a folding type portable information terminal device in which an upper housing provided with a receiving portion and a lower housing provided with a transmitting portion are coupled to each other to be foldable through a hinge portion,

wherein the lower housing is formed to be longer than the upper housing, a protruded portion of the lower housing is protruded from the upper housing in a folding condition and a display device is provided on an opposed surface side of the protruded portion to the upper housing.

In the foregoing, suitably, there is provided operating means for changing a direction of information to be displayed on the display device and for sequentially changing information to be displayed on the display device, and the operating means can be operated during talking. Furthermore, the operating means is operated during talking to return the information displayed on the display device to information obtained before arrival of an incoming call when the talking is ended.

In the foregoing, more suitably, a display device having a large display area (which will be hereinafter referred to as a large display device) than that of the display device (which will be hereinafter referred to as a small display device) is provided on a face which is hidden in such a condition that the upper housing and the lower housing are folded and which is exposed in an opening condition, and furthermore, the large display device is provided in the upper housing so that the folding type portable information terminal device is constituted.

The object can be attained by the folding type portable information terminal device, wherein the small display device is caused to display any of a time, a time taken for use, a state of the use, a residual capacity of a battery, various setting modes, a report message of arrival of an incoming call and manner information about an apparatus.

In the foregoing, suitably, the report message to be displayed on the small display device is a telephone number of the other person or a name of the other person corresponding to the telephone number of the other person at time of arrival of a voice and is a mail address of the other person or a name of the other person corresponding to the mail address of the other person at time of arrival of a mail, and furthermore, the large display device is caused to display a face image of the other person corresponding to the report message displayed on the small display device.

In the foregoing, suitably, text data input at time of mail transmission, text data received by mail or input character strings of registered data are displayed on the large display device. When the operating means is operated in the middle of a voice call in an opening condition, moreover, a direction of the information displayed on the small display device is changed and displayed. When the operating means is operated in the middle of the voice call in the opening condition, furthermore, a plurality of information in a time, a time taken for use, a state of the use, a residual capacity of a battery, various setting modes, a report message of arrival of an incoming call and manner information about an apparatus are sequentially switched and displayed on the small display device.

In the case in which an incoming call arrives in the middle of the display of the information on the small display device and another information is instead displayed on the small display device, furthermore, the information displayed on the small display device is returned to the information obtained before the arrival of the incoming call when talking is ended. Alternatively, when another incoming call arrives during a voice call, information about a source of the incoming call is displayed on the small display device.

In the portable information terminal device according to the invention, character information and image information which are displayed on the small display device can be visually recognized by the user in the folding condition. In the opening condition, moreover, the user can simultaneously confirm visually the character information and the image information which are displayed on the small display device and the large display device. Also in such a state that the user puts the vicinity of the receiving portion to his (her) ear and thus receives a call, furthermore, the user can visually confirm the character information and the image information which are displayed on the small display device during talking.

At this time, if the information displayed on the small display device is written transversely and can be seen with difficulty, the operating means can be operated to write the same information vertically, and furthermore, writing from left to right can also be changed to writing from right to left. As the information to be displayed on the small display device, any of a time, a time taken for use, a state of the use, a residual quantity of a battery, various setting modes, a report message of arrival of an incoming call and manner information about an apparatus is displayed or they are switched and displayed so that the user can acquire necessary information in the middle of the use with the terminal device put to his (her) ear.

Moreover, when an incoming call arrives in the folding condition, source identification information is displayed on the small display device provided in a place which can be seen without opening the terminal device. Therefore, it is possible to relieve troubles made by opening the terminal device at each time. Moreover, in the case in which the user can open the terminal device to see the large display device at time of talking, he (she) can identify the other person who cannot be remembered by only a name because of the display of the face image of the other person.

Furthermore, the information displayed on the small display device is returned to the original information display by the end of the talking. Consequently, the information confirmed visually can be set to non-display by no operation and the secrecy and protection of the information known by only the user can also be realized.

### BRIEF DESCRIPTION OF THE DRAWINGS

FIG. 1 is a perspective view showing the appearance of a folding type portable telephone according to an embodiment of the invention (an opening condition).

FIG. 2 is a perspective view showing the appearance of the folding type portable telephone according to the embodiment of the invention (a closing condition).

FIG. 3 is a sectional view showing the folding type portable telephone illustrated in FIG. 1.

FIG. 4 is a view showing a state in which a body portion is opened, and a receiving portion is put to a user's left ear and a transmitting portion is brought close to the vicinity of a mouth for use (calling).

FIG. 5 is a block diagram for explaining an operation to be carried out when the folding type portable telephone illustrated in FIG. 1 receives a voice communication.

FIG. 6 is a block diagram for explaining an operation to be carried out in which the folding type portable telephone illustrated in FIG. 1 receives a non-voice communication.

FIG. 7 is a view showing the appearance of a conventional folding type portable telephone (a closing condition).

FIG. 8 is a view showing the appearance of the conventional folding type portable telephone (an opening condition).

In the drawings, the reference numeral 1 denotes an upper housing, the reference numeral 2 denotes a lower housing, the reference numeral 3 denotes a hinge portion, the reference numeral 7 denotes a receiving portion, the reference numeral 8 denotes a liquid crystal display, the reference numerals 9 and 18 denote an operating portion, the reference numeral 19 denotes a transmitting portion and the reference numeral 24 denotes a liquid crystal display.

### BEST MODE OF CARRYING OUT THE INVENTION

An embodiment of the invention will be described below with reference to the drawings.

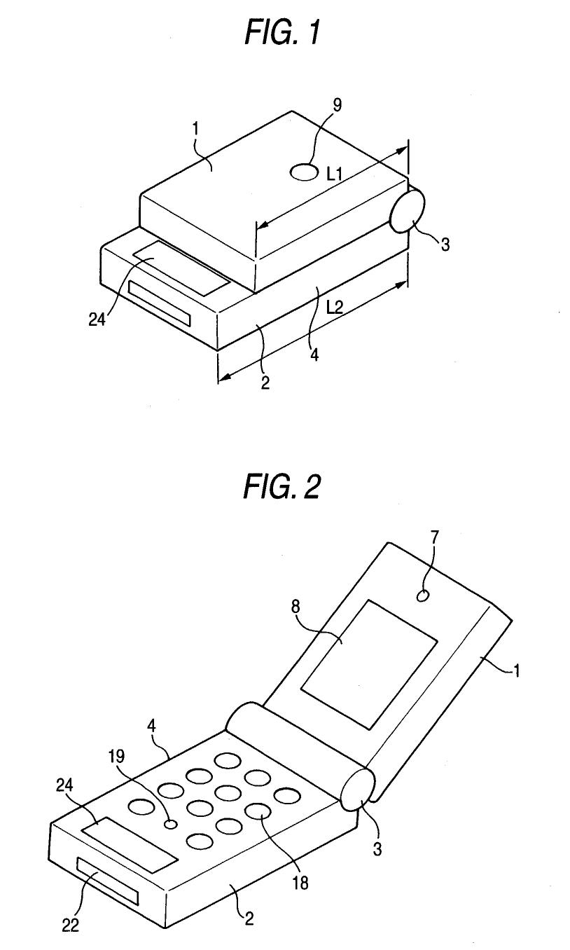

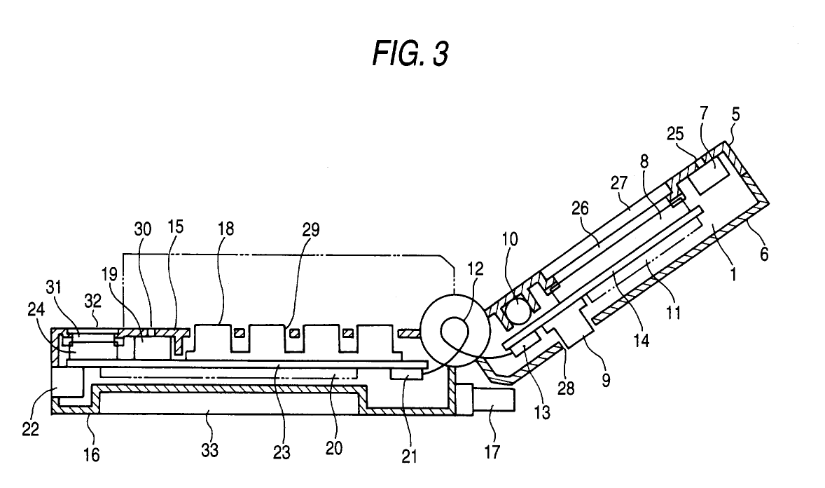

FIGS. 1 and 2 are views showing the appearance of a folding type portable telephone according to an embodiment of a folding type information terminal device, FIG. 1 showing a closing condition and FIG. 2 showing an opening condition. Moreover, FIG. 3 is a sectional view showing a state in which the folding type portable telephone illustrated in FIGS. 1 and 2 is opened (a two-dotted chain line in FIG. 3 shows a state in which the portable telephone is closed).

In the folding type portable telephone according to the embodiment, an upper housing 1 and a lower housing 2 are rotatably coupled to each other through a hinge portion 3 formed on each of the housings so that a body portion 4 is formed. The portable telephone is closed (folded) such that the upper housing 1 and the lower housing 2 are opposed to each other during a non-call, and is opened for use during a call.

The upper housing 1 is formed to be almost boxshaped with an upper cover 5 fitted in an upper case 6, and accommodates a receiving portion (speaker) 7 for outputting a voice, an almost flat liquid crystal display 8 (a large display device) for displaying characters, symbols, numerals and images, an operating portion 9 for printing characters and symbols and executing voice recording during a call and voice reproduction during a non-call, a vibrator portion 10 for giving a notice that an incoming call arrives through a vibration, and an upper body portion printed board 14 on which a connector 13 is mounted, and a control circuit portion 11 is formed on the printed board 14 and a flexible printed board (FPC) 12 is connected to the connector 13. If the body portion 4 is closed and the operating portion 9 is operated when an incoming call arrives, telephone receiving can be started.

The lower housing 2 is formed to be almost box-shaped with a lower cover 15 fitted in a lower case 16. The lower housing 2 is provided with a liquid crystal display 24 (a small display device) for displaying different information from that of the liquid crystal display 8 provided in the upper housing 1. Furthermore, the lower housing 2 accommodates an antenna 17. for transmission and receipt, an operating portion 18 having the function of printing and inputting characters, symbols and numerals and changing the direction of a character displayed on the liquid crystal display 24, a transmitting portion (microphone) 19, a radio circuit portion 20, a connector 21 connected to the FPC 12, a connector for an interface (an I/O connector for external control) 22 to which a contact plug (not shown) for a charging system, a radio signal system or a voice or image signal system is attached from the outside, and a lower body portion printed board 23 on which the connectors 21 and 22 and the radio circuit portion 20 are mounted.

The FPC 12 has one of ends inserted in the connector 13 on the upper housing 1 side, is wound in the hinge portion 3 and has the other end inserted in the connector 21 of the lower housing 2. Consequently, the upper body portion printed board 14 and the lower body portion printed board 23 are electrically connected to each other.

The surface side of the upper housing 1 is provided with a sound hole 25 for guiding a voice output from the receiving portion 7 to the outside of the housing and a window 26 for a liquid crystal display through which a character displayed on the liquid crystal display 8 can be seen from the outside of the housing, and the window 26 for a liquid crystal display is covered with a transparent cover 27. The back side of the upper housing 1 is provided with an operating portion hole 28 for protruding the operating portion 9.

The surface side of the lower housing 2 is provided with a plurality of operating portion holes 29 for protruding a key top of the operating portion 18 to the outside in an almost central part, a mouthpiece 30 for transmitting a voice toward the transmitting portion 19, and a window 31 for a liquid crystal display through which a character displayed on the liquid crystal display 24 can be seen from the outside of the housing, and the window 31 for a liquid crystal display is covered with a transparent cover 32. A battery pack 33 for feeding a power to a circuit portion is removably attached to the back side of the lower housing 2 and the outer surface of the battery pack 33 is flat.

Next, the sizes of the upper housing 1 and the lower housing 2 will be described. As shown in FIG. 1, the upper housing 1 has a length L1 from the center of the hinge portion 3 and the lower housing 2 has a length L2 (>L1) from the center of the hinge portion 3. When the battery pack is put toward the lower side in a state in which the body portion 4 is closed such that the liquid crystal display 8 and the operating portion 18 are opposed to each other, the battery pack 33 can be stationarily put stably because the outer surface thereof is flat, and furthermore, the sound hole 25, the liquid crystal display 8 and the operating portion 18 are covered and cannot be thereby seen. On the surface side of the lower housing 2, however, the liquid crystal display 24 provided in a longer portion (a portion of L2−L1) than the upper end of the upper housing 1 is exposed and the liquid crystal display 24 can be recognized visibly also in a state in which the body portion 4 is closed.

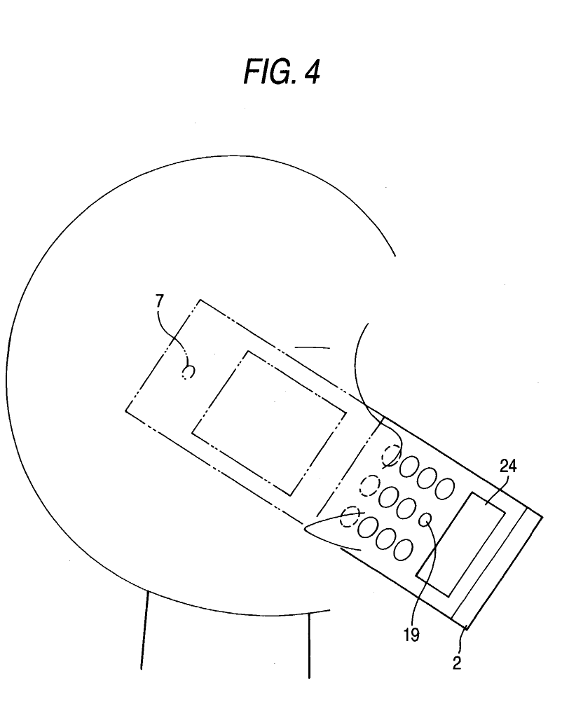

The body portion 4 having the structure described above is set in a receipt waiting/incoming calling state in both opening/closing conditions. After an incoming call arrives, talking can be carried out in the opening condition. At time of a call, as shown in FIG. 4, for example, a user puts the sound hole 25 (or the receiving portion 7) to his (her) ear and thus receives a voice, and the user's voice is transmitted to the other person through the transmitting portion 19. In the case in which the user talks apart from the body 4 set in the opening condition by using an earphone and microphone which is not shown, moreover, the talking can be carried out in such a state that both the liquid crystal displays 8 and 24 can be recognized visually at the same time.

In the example shown in FIG. 4, the user opens the body portion 4, puts the receiving portion 7 to his (her) left ear and brings the transmitting portion 19 close to the vicinity of a mouth for use (calling). In this case, the liquid crystal display 8 is close to a left cheek (a left head portion). Therefore, the user cannot visually recognize the contents displayed on the liquid crystal display 8 during a call. However, the liquid crystal display 24 is provided on the front side of the head portion. Consequently, when the user slightly changes an angle, the displayed contents can be recognized visually. In the case in which information is displayed, it can is easily be read by changing an eyelevel.

At this time, the left end side of the liquid crystal display 24 is turned close to a ground with respect to the right end side. When characters are displayed on the liquid crystal display 24 in a transverse line from the left end side in this state, the user reads the characters with difficulty. For this reason, the user operates the operating portion 9 which does not come in contact with the head portion also during calling, thereby displaying a character string on the liquid crystal display 24 in a vertical line from the right end side. In the case in which the user receives a call with a right ear, the character string can also be displayed in the vertical line from the left end side.

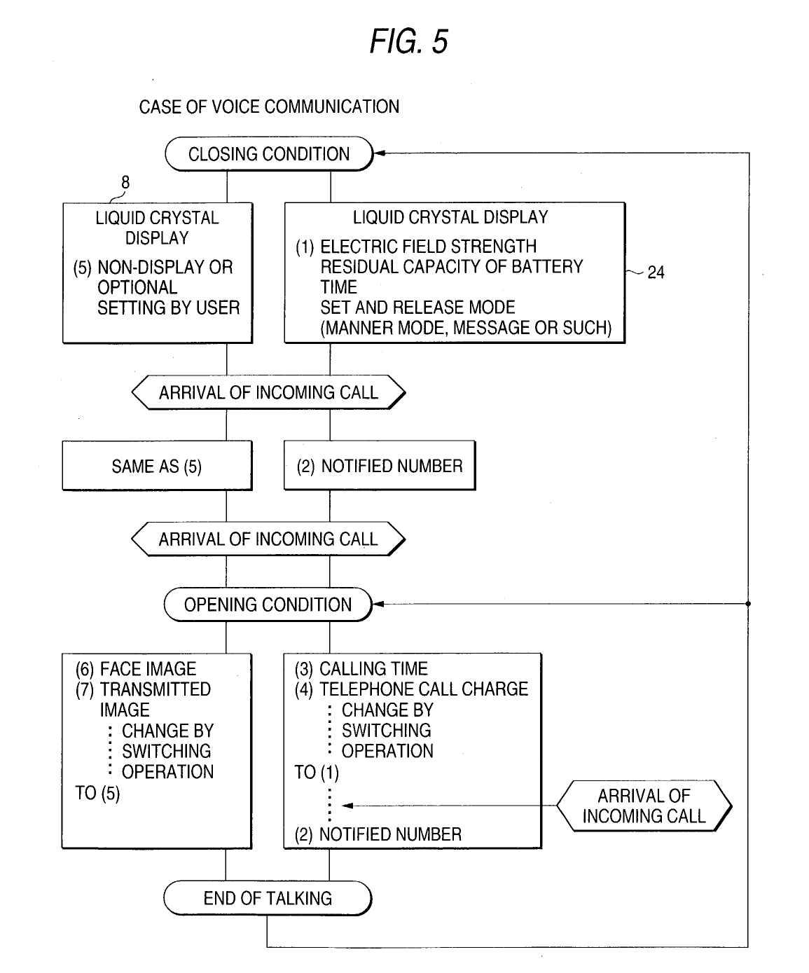

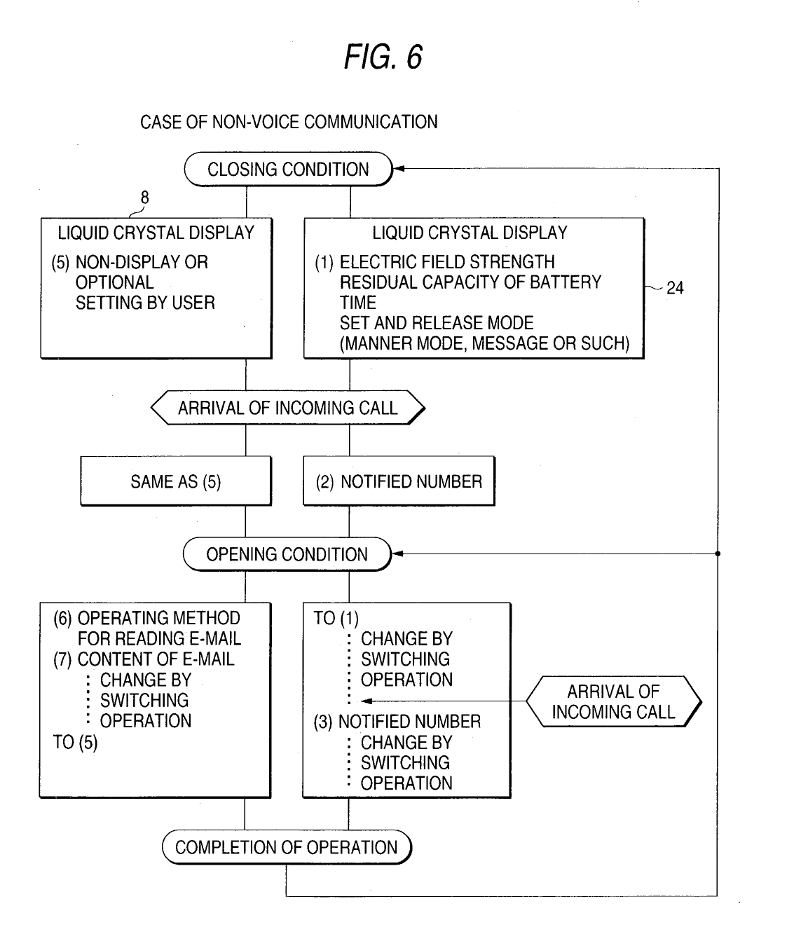

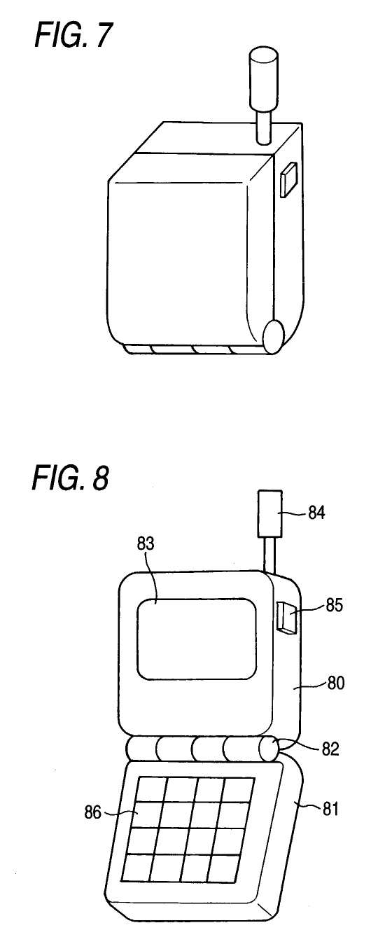

FIGS. 5 and 6 are views for explaining the operation of the folding type portable telephone according to the embodiment, FIG. 5 showing an operation to be carried out when a voice communication arrives and FIG. 6 showing an operation to be carried out when a non-voice communication (an electronic mail) arrives.

In FIG. 5, in the waiting state in which the body portion 4 is closed, the liquid crystal display 24 displays information comprising characters, numerals and images, for example, information indicative of a time, an electric field strength or a residual quantity of a battery, and status information about a mode set by a user such as a manner mode to be reported by a non-sound at time of the arrival of an incoming call, that is, the operation of a vibrator or a message mode for electronically recording the voice of the other person. At this time, since the body portion 4 is folded and the user cannot see the liquid crystal display 8, the liquid crystal display 8 may be set to non-display.

When a voice communication (a call) arrives in this state, a part or all of the information displayed on the liquid crystal display 24 is/are set to the non-display and information for specifying a sender (for example, the telephone number of the other person and the name of a sender registered in relation to the telephone number of the other person) is then displaced instead. Alternatively, the information displayed on the liquid crystal display 24 during waiting is exactly displayed continuously and the information for specifying the sender is displayed additionally. In the case in which the number is not notified, display is carried out such that the purport can be distinguished.

When the user operates the operating portion 9 to set a receiving state and opens the body portion 4 to start a call, a time passed from the start of the arrival of the incoming call (a calling time) is displayed on the liquid crystal display 24. Moreover, another information is displayed on the liquid crystal display 8. For example, another information includes an image (a face) related to the telephone number information of the other person and a transmitted image. By displaying the face image, the user can confirm, with the face after opening the body portion 4, the other person which can be recognized by only the name of the other person before opening the body portion 4.

In order to register the face image and the telephone number in relation to each other, for example, it is preferable to photograph the face of the other person by means of a camera which is provided in the portable telephone and is not shown or a camera connected to the connector 22 when meeting the other person and to display and register a telephone number on the liquid crystal display 8 or 24 while displaying an image thus picked up over the whole area of the liquid crystal display 8. Any user cannot remember the other person by the telephone number or the name in some cases. However, the user can remember the other person by confirming the image of a face. Thus, it is possible to provide a more convenient telephone book function for the user.

When the user operates the operating portion 9 during talking, calling time information displayed on the liquid crystal display 24 is changed into telephone call charge information or time information, and furthermore, the displayed information is sequentially changed in preset order. In the folding type portable telephone according to the embodiment, therefore, the user can confirm various required information by means of the liquid crystal display 24 while maintaining such an attitude that the user puts the receiving portion to his (her) ear. Moreover, if the operating portions 9 and 18 are caused to have the function capable of changing the contents displayed on the liquid crystal display 8, the user can acquire various information from both the liquid crystal displays 8 and 24 when freehand using the folding type portable telephone according to the embodiment.

Furthermore, when another incoming call arrives during talking, the user can acknowledge the arrival of the incoming call while talking if the purport is displayed on the liquid crystal display 24, and furthermore, can also specify a sender if the telephone number of the other person is notified. At this time, even if the information displayed on the liquid crystal display 24 is temporarily switched into a number notice, the information can be acquired continuously if information obtained before the arrival of another incoming call is set to be displayed again after a predetermined operation or the passage of a predetermined time. Consequently, there is no problem.

When the user operates the operating portion 18 to end the call, the information displayed during talking is displayed continuously for a predetermined time on both the liquid crystal displays 8 and 24 and the information displayed before the arrival of an incoming call is then displayed again. Also in the case in which the incoming call arrives in the opening condition, the same operation is carried out and the description of the operation will be therefore omitted.

Next, an operation to be carried out when an electronic mail arrives will be described with reference to FIG. 6. In the waiting state in which the body portion 4 is closed, the liquid crystal displays 8 and 24 carry out the same display as that in the case of the arrival of a voice in FIG. 5. It is assumed that the electronic mail arrives in this state. In this case, the information displayed on the liquid crystal display 24 is displayed continuously and the report of the arrival of an incoming call in characters or symbols is displayed additionally. Alternatively, setting can also be carried out such that a part or all of the information which have already been displayed on the liquid crystal display 24 is/are not displayed at time of the arrival of an incoming call but information for specifying the mail address of a sender or the sender (for example, the telephone number of the other person or the name of a sender registered in relation to the telephone number of the other person) is displayed instead.

Furthermore, when a new electronic mail arrives, the purport is displayed on the liquid crystal display 24. Even if the user opens the body portion 4, the display of the liquid crystal display 24 is continuously carried out (no change) or a state obtained before the arrival of the electronic mail is set again (depending on the prior setting to be carried out by the user). Another information is displayed on the liquid crystal display 8 which can be seen from the user. For example, another information includes a menu screen such as an operating method of reading an electronic mail or a method of replying to the electronic mail. By operating the operating portion 18, the user can select and determine one of functions from the menu. In the case in which image information is included in a received mail or is attached thereto, moreover, the image can also be displayed.

When a new voice communication or electronic mail arrives while the user opens the electronic mail and displays the contents of the electronic mail on the liquid crystal display 8, and simultaneously, operates an apparatus, it is necessary to set a part of the displayed information to non-display and to then display a report message indicative of the arrival or to previously provide a display area for displaying the report message in the liquid crystal display 8 if the report message is to be displayed on the liquid crystal display 8. Consequently, the text of the electronic mail can be displayed in only a part of the liquid crystal display 8 or the size of characters is to be reduced.

In the folding type portable telephone according to the embodiment, however, a report message can be displayed on the liquid crystal display 24 in place of the liquid crystal display 8. For this reason, even if another incoming call arrives during the use of the whole surface of the liquid crystal display 8, it is not necessary to reduce the screen of the liquid crystal display 8 or to decrease the size of the characters.

In addition, the user can read the report message displayed on the liquid crystal display 24 also during talking. By operating the operating portion 9 during the talking, furthermore, the information to be displayed on the liquid crystal display 24 can be changed from the report message into calling time information or telephone call charge information in the same manner as in the description with reference to FIG. 5. Consequently, it is possible to acquire various information also after the display of the report message. Also during freehand use, moreover, the same effects can be obtained.

As described above, according to the embodiment of the invention, since the liquid crystal display is exposed to a part of the lower housing which is not covered with the upper housing, information required by the user can be displayed on this portion in both the opening and closing conditions so that the operability of the folding type portable information terminal device can be enhanced. In addition, it is possible to display information without impeding the using state during the use. Consequently, it is possible to provide a suitable apparatus for the user as an information apparatus.

When receiving a music delivery by using the terminal device and displaying lyrics on the liquid crystal display while listening to the music, moreover, the user can display the whole lyrics on a liquid crystal display having a large screen, can display the lyrics as a telop on a liquid crystal display having a small screen according to the progression of a song or can display, on the small screen, information about the name of an artiste or the title of a musical composition.

While a method of creating an electronic mail has not been described, it is also possible to display other information on a small screen while displaying input characters on a large screen as much as possible in this case. Consequently, a convenient using way can be achieved.

Thus, it is preferable that the portable information terminal device of this type should display information as much as possible at the same time. Accordingly, the terminal device according to. the embodiment which has such a structure that information including images, characters and numerals is displayed as much as possible on a liquid crystal display having a large screen and information such as the residual capacity of a battery is displayed on a liquid crystal display having a small screen can be convenient to the user. Thus, a useful portable apparatus can be obtained.

While the invention has been described in detail with reference to the specific embodiment, it is apparent to the skilled in the art that various changes and modifications can be made without departing from the spirit and scope of the invention.

The application is based on JP-A-2001-21951 filed in Jan. 30, 2001 and the contents thereof are cited by reference herein.

### INDUSTRIAL APPLICABILITY

According to the invention, the user can see various information without feeling troublesome, and furthermore, display can be carried out in an easy watching manner.

1. (Amended) A folding type portable information terminal device constituted by an upper housing having a receiving portion on either end side and a first display portion on an opposite end side, and a lower housing having a second display portion and coupled to the opposite end side of the upper housing through a hinge portion so as to be foldable,
wherein the lower housing is provided with a protruded portion in which the lower housing is protruded from the either end side of the upper housing in such a state that the receiving portion and the first display portion are folded to be opposed to the lower housing, and the second display portion is provided on an opposed face side of the protruded portion to the upper housing.

2. (Amended) The folding type portable information terminal device according to claim 1,
further comprising operating means for changing a direction of information to be displayed on the second display portion.

3. (Amended) The folding type portable information terminal device according to claim 1, further comprising:
operating means for sequentially changing information to be displayed on the second display portion.

4. (Amended) The folding type portable information terminal device according to claim 2 or 3,
wherein the operating means can be operated during talking.

5. (Amended) The folding type portable information terminal device according to claim 4, further comprising:
means for operating the operating means during talking to return the information displayed on the second display portion to information obtained before arrival of an incoming call when the talking is ended.

6. (Amended) The folding type portable information terminal device according to any of claims 1 to 5,
wherein the first display portion is provided on a face of the upper housing which is hidden in such a condition that the upper housing and the lower housing are folded and which is exposed in an opening condition.

7. (Amended) The folding type portable information terminal device according to claim 6,
wherein a display area of the first display portion is larger than that of the second display portion.

8. (Amended) The folding type portable information terminal device according to claim 1,
wherein the second display portion is caused to display any of information about a residual capacity of a battery, information about an electric field strength, a time, a time taken for use, a calling time, information about arrival of an incoming call, various setting modes and manner information about a device.

9. (Amended) An information display method of the folding type portable information terminal device according to claim 8,
wherein the information about arrival of an incoming call to be displayed on the second display portion is a telephone number of the other person or a name of the other person corresponding to the telephone number of the other person at time of arrival of a voice and is a mail address of the other person or a name of the other person corresponding to the mail address of the other person at time of arrival of a mail.

10. (Amended) The information display method of the folding type portable information terminal device according to claim 9,
wherein the first display portion is caused to display a face image of the other person corresponding to the information about arrival of an incoming call which is displayed on the second display portion.

11. (Amended) The information display method of the folding type portable information terminal device according to any of claims 8 to 10,
wherein text data input at time of mail transmission, text data received by mail or input character strings of registered data are displayed on the first display portion.

12. (Amended) The information display method of the folding type portable information terminal device according to any of claims 8 to 11,
wherein a direction of the information displayed on the second display portion is changed and displayed in the middle of a voice call in an opening condition.

13. (Amended) The information display method of the folding type portable information terminal device according to any of claims 8 to 12,
wherein the information about a residual capacity of a battery, the information about an electric field strength, the time, the time taken for use, the calling time, the information about arrival of an incoming call, the various setting modes and the manner information about a device are sequentially switched and displayed on the second display portion in the middle of a voice call in the opening condition.

14. (Amended) The information display method of the folding type portable information terminal device according to any of claims 8 to 13,
wherein in the case in which an incoming call arrives in the middle of the display of the information on the second display portion and another information is instead displayed on the second display portion, the information displayed on the second display portion is returned to the information obtained before the arrival of the incoming call when talking is ended.

15. (Amended) The information display method of the folding type portable information terminal device according to any of claims 8 to 14,
wherein when another incoming call arrives during a voice call, information about a source of the incoming call is displayed on the second display portion.
